(19) United States
(12) Patent Application Publication
(10) Pub. No.: US 2008/0313173 A1
(43) Pub. Date: Dec. 18, 2008

(54) METHOD AND APPARATUS FOR RATING, DISPLAYING AND ACCESSING COMMON COMPUTER AND INTERNET SEARCH RESULTS USING COLORS AND/OR ICONS

(76) Inventor: Christophe Thomas Popper, Shelton, CT (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 12/120,601

(22) Filed: May 14, 2008

Related U.S. Application Data
(63) Continuation-in-part of application No. 11/177,768, filed on Jul. 11, 2005, now abandoned.
(60) Provisional application No. 60/587,468, filed on Jul. 13, 2004.

(51) Int. Cl. G06F 7/06; G06F 17/30

(52) U.S. Cl. 707/5; 707/E17.108

(57) ABSTRACT

A new and safe way to display, limit, and rate search results. New Methods and Apparatus for Rating, Displaying and Accessing common computer and Internet Search results using Colors. It is known that search results can be filled with both inappropriate and offensive materials. This invention provides for new means of displaying search results, while also allowing for new means of displaying search results, while also allowing for end-users to clearly identify the differences between all search results, and to which they can or cannot have access.

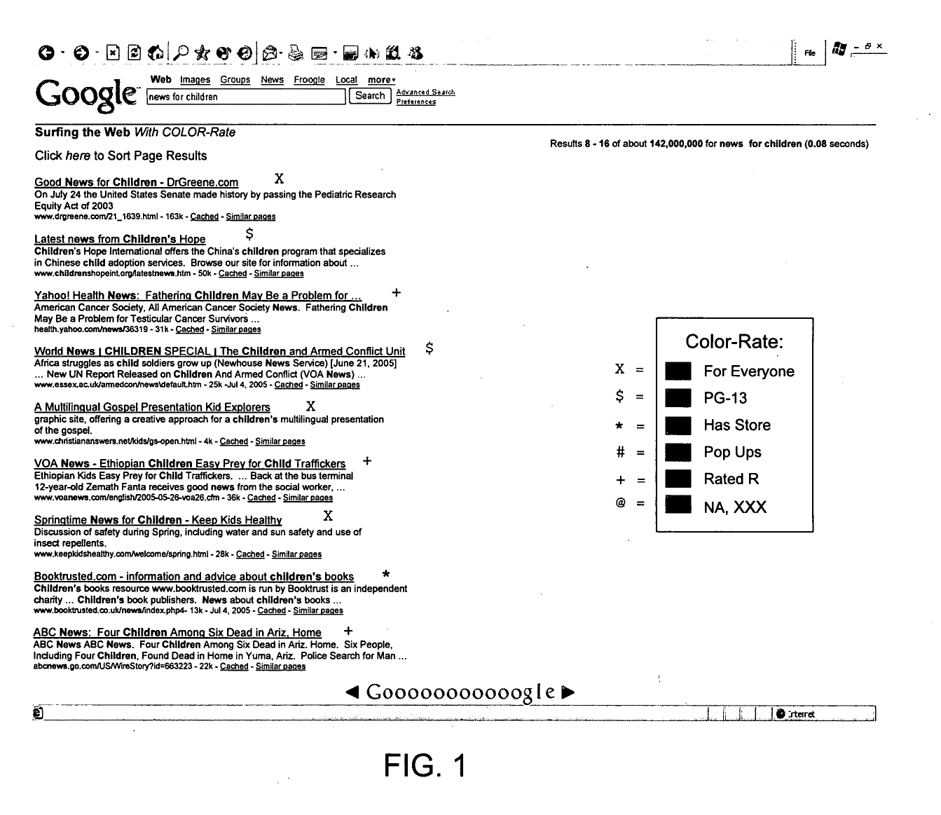

### CROSS-REFERENCE TO RELATED APPLICATIONS

This application claims the benefit of the filing date of U.S. Provisional Application No. 60/587,468 filed on Jul. 13, 2004 and is a continuation-in-part of U.S. patent application Ser. No. 11/177,768, filed on Jul. 11, 2005, all of which are incorporated herein by reference.

### FIELD OF INVENTION

The present invention relates to Internet searching, and more particularly to making internet search results safer and more relevant, by assigning colors and/or icons to categorize and rate search results.

### BACKGROUND OF INVENTION

The problem when searching the internet, via common search engines such as Yahoo™, Google™, MSN™, AskJeeves™, AOL search™, A9 com™, and other search engines, is that you can get thousands of results, and a typical search result page includes a lot of text (description) and the Link (url) that you can click on to access that page.

While prior art can give you a screenshot of the page you are about to click, a user is not made aware of it's age-rating (PG, MA, PG-13, R etc.), and a user has to read the full description (which is sometimes also misleading) before even accessing the actual page. Therefore, the current and prior art methods make searching and finding websites:

a) Slow

b) Potentially inaccurate

c) Potentially harmful to children whom might end up finding XXX websites etc.

Solutions that exist today, include:

“Safe search” where the database from which search results are fetched have been filtered. One of our products, KBsearch.com does that, so does, Google Safe Search™, but this limits the potential search results, and still does not provide for a clear understanding as to what type of website (as a result of your search query) you might actually be clicking towards.

In addition, parental filters also exist, as those provided by AOL™, again these are restrictive and “non-guiding.”

Search engines have also focused their attention on deploying and developing search algorithms in hopes of matching as closely as possible individual queries with millions of potential results. These search algorithms use a combination of both meta-tags and actual page content.

In the prior and existing arts, no attention has been given/taken, towards color coding search results (or adding a small icon next to it—rather than a screenshot) as a way to give each potential result an easy to identify Rating System that would allow common web searchers (users) to instantly know what kind/type/genre/age group that specific search result (individual url listed) is suitable for.

There is clearly a need for this invention.

### SUMMARY OF INVENTION

This invention is concerned with the way in which search results are displayed when someone is using any existing search engine on the internet. This invention provides an easy method for identifying websites that are either potentially offensive, may contain sexually explicit material and/or may not be suitable for children or other age groups. Using colors as a means to display the functionality of this invention, icons (small images) can also be used to replace the colors and/or add a more precise categorizing system.

This invention is concerned with guiding and pre-warning a web user of what his/her search results include: Whether it be a rating based on the content's targeted age group, and/or whether that content indeed includes simple elements such as pictures etc. suitable (or not) for that same age group.

This invention will display search results in different colors, for each of the results depending on whether these are “Rated G PG13, R, MA, etc.” and this invention will also add a descriptive icon to show “Pictures,” Videos” etc.

This invention can be implemented in many ways, here are three simple yet comprehensive methods by which the invention can be deployed:

a) Directly, within the database of search results, by “tagging” the search results with identifiers. (Running a small application that could tag items within a database)

b) Within an internet browser, using a Plug-In that would “pre-read” potential search results, and then display them with associated color codes.

c) By individual website owners who could put special code in their pages, relevant to their page content.

Clearly, the best method would be via a Plug-in, for this would make the whole process and implementation of the invention very simple.

A plug-in is a program written by someone that is integrated into another application. The program plugs into the application. Plug-ins often provide additional functionality that isn't available in the application.”

One of the ways this invention could be implemented is via a Plug-in for Web Browsers (all types: wireless, Mozilla, IE, Netscape, FireFox etc, . . . )

A direct rendition of this invention, would be that Red search results would mean Rated MA, Green search Results could mean that “It's a Store,” Blue could mean Rated G. and so on. A small icon (with a camera, printer, camcorder etc.) could further give a visual interpretation of what the link (url) contains.

Clearly the color scheme and their applications can be varied and a multitude of color combinations is possible. The Plug-in could also be used to restrict access to such sites as those marked in red (rated R) etc. by a Parent.

### BRIEF DESCRIPTION OF THE DRAWINGS

These drawings actually show a Screenshot of Search results using the present invention, Color-Rat:

Fig. I: A Google search page with the results shown in a color coded manner.

### DETAILED DESCRIPTION OF THE PREFERRED EMBODIMENT

As shown in the Figure, the present invention displays search results in different colors for each of the results, depending on whether the web pages behind the links are “Rated G, PG 13, R, MA, and similar ratings. In accordance with the invention, a descriptive icon may also be added adjacent to each search result to identify whether the web page includes “Pictures,” Videos” and other features. Because the drawing is in black and white, the colors in the chart are indicated by unique reference symbols and the corresponding search results are each marked with a symbol so that a search result can be properly associated with a rating.

This invention can be implemented in many ways. Three simple yet comprehensive methods by which the invention can be deployed are as follows:

a) Directly, within the database of search results, by “tagging” the search results with identifiers. This could be accomplished by running a small application that could tag items within a database.

b) Within an internet browser, by using a Plug-In that would “pre-read” potential search results, and then display the listed search results in the appropriate colors according to the associated color codes.

c) By individual website owners who could put special code in their pages, relevant to their page content, which would provide the requisite information to result in the correct color code being displayed on the search results.

The best method would probably be via a Plug-in, in that this approach would make the whole process and implementation of the invention very simple, and would work for all web sites, without relying on individual website owners to judge their own content or by running a separate tagging application.

A direct rendition of this invention, would be that Red search results would mean Rated MA, Green search Results could mean that “It's a Store” (that is, that the web site offers products for sale), Blue could mean Rated G and so on. A small icon (with a camera, printer, camcorder etc.) could further give a visual interpretation of what the link (url) contains.

The color scheme and the application of the color scheme to the results can be varied and a multitude of color combinations is possible. The Plug-in could also be used to restrict access to such sites as those marked in red (rated R) etc. by a Parent.

The present invention provides the following methods and solutions:

A solution to visually warn and protect children from accessing/clicking on potentially offensive material content on search results on the Internet, without restricting the search results.

A method for automatically rendering hyperlinks color coded based on page meta-tags and content.

A method for using color codes to differentiate online stores (where a child under 13 will probably have nothing to do—No credit card) and of clearly and easily guiding children towards the right site(s).

A method that can propagate color codes within a database, depending on specific criteria: Keywords, Meta-Tags, etc.

A method by which color coding of the results can be done via a Plug-In.

A method of color coding search results, that is “stand-alone” and independent of the search engine used (Google, Yahoo, MSN, etc . . . )

A method that is multi platform, cross-browser, and self sustained, for and to color code search results.

A method that can also be dedicated to a search engine.

A method by which colors can also be accompanied with icons to better visualize the rating: MA, PG, R, and other ratings.

A method by which colors indicate specific attributes and/or ratings.

A method by which a user can choose which colors can be user configured, where users assign their own colors to potential search results.

A method by which the color coding can lead to user access restrictions via a control panel.

A method of universally associating colors to rate and describe links: Such a method could become the basis for implementing a regulation or law governing internet usage.

A method by which color coding allows for faster browsing and increased relevance of search results.

A method by which icons can be used in conjunction with the colors to give a better idea as to what the page rated contains, such as videos, pictures, etc.

A method by which numbers could also be added to give a greater “scale” to the rating.

Although the invention has been described with reference to certain specific embodiments, various modifications thereof will be apparent to those skilled in the art without departing from the scope of the invention as outlined in the claims appended hereto. A person skilled in the art would have sufficient knowledge of at least one or more of the following disciplines: computer programming, search engine optimization and computational linguistics.

1. A method for displaying search results for searches performed on a database, comprising:
using a search engine to search the internet for a selected informational content and identifying search results which include the selected informational content,
attributing a rating to the search results depending upon the content of the information contained in the search results,
displaying the search results with a separate attribute for each search result dependent upon the rating attributed to that search result.

2. A method according to claim 1, wherein the attributing a rating and displaying the search results does not restrict the search results.

3. A method according to claim 1, wherein the attribute for each search result comprises a color for the text of the displayed search result.

4. A method according to claim 1, wherein the attribute for each search result comprises an icon representing a particular rating for the search result.

5. A method according to claim 1, wherein the content of the information contained in the search results includes meta-tags associated with the search results.

6. A method according to claim 1, wherein the displayed search results comprise hyperlinks.

7. A method according to claim 1, wherein a result rating includes the status of a search result being an on-line store.

8. A method according to claim 1, further including a step of propagating color codes within the database being searched, depending upon specific criteria.

9. A method according to claim 1, wherein the database comprises the internet.

10. A method according to claim 8, wherein a plug-in program is utilized to propagate color codes within the database.

11. A method according to claim 1, wherein the step of attributing a rating to the search results is performed independently of the use of the search engine.

12. A method according to claim 1, wherein the step of attributing a rating to the search results is performed by the search engine.

13. A method according to claim 1, wherein the attribute for each search result comprises a color for the text and the display of an icon for each of the displayed search results.

14. A method according to claim 1, wherein the particular attributes used for each rating may be selected by a user.

15. A method according to claim 1, wherein the attributing a rating is used as a basis for restricting the search results.

16. A method according to claim 1, wherein some icons include numerals to provide a scale to a particular rating.

17. A method for enhancing the review of search results for searches performed on a database, comprising:
using a search engine to search the internet for a selected informational content and identifying search results which include the selected informational content,
attributing a rating to the search results depending upon the content of the information contained in the search results,
displaying the search results with a separate attribute for each search result dependent upon the rating attributed to that search result, and
ranking the search results in accordance with the attribute displayed with each search result.
